(19) United States
(12) Patent Application Publication
(10) Pub. No.: US 2025/0117117 A1
(43) Pub. Date: Apr. 10, 2025

(54) METHOD FOR MANAGING PHOTOGRAPHING INFORMATION IN BUILDING SUBJECT TO SAFETY DIAGNOSIS, AND WORKER TERMINAL HAVING INSTALLED THEREON PROGRAM FOR EXECUTING METHOD FOR MANAGING PHOTOGRAPHING INFORMATION IN BUILDING SUBJECT TO SAFETY DIAGNOSIS

(71) Applicant: HANSTYLE ENGINEERING CO., LTD., Seoul (KR)

(72) Inventor: Da Woon JEONG, Seoul (KR)

(21) Appl. No.: 18/567,358

(22) PCT Filed: Apr. 4, 2022
(86) PCT No.: PCT/KR2022/004771

§ 371 Date: Jan. 29, 2024

(30) Foreign Application Priority Data
Jun. 7, 2021 (KR) 10-2021-0073695

(51) Int. Cl. G06F 3/0484; H04N 5/76

(52) U.S. Cl. CPC G06F 3/0484; H04N 5/76

(57) ABSTRACT

Provided are a method for managing photographic information in a safety assessment target building and a worker terminal installed with a program for executing the method for managing photographic information in a safety assessment target building. Provided is implemented through processes which are performed by the worker terminal and include: capturing a photographic image of an inspection target area in a photographing space, which is a space where a worker performs photography; storing a voice memo of the worker in association with the photographic image of the inspection target area; and generating icons for calling information including an icon for calling the photographic image and an icon for calling the voice memo on a drawing image of the photographing space.

### TECHNICAL FIELD

The present invention relates to a method for managing photographic information in a safety assessment target building and a worker terminal installed with a program for executing the method for managing photographic information in a safety assessment target building, and more particularly, to a method for managing photographic information in a safety assessment target building, in which not only photographing point and photographing direction information corresponding to each photographic image taken by a worker while moving within a photographing space of the building etc. may be additionally generated in a drawing image of the corresponding photographing space, but also memo information and reference data information of a worker may be stored in association with the photographic image along with photography, thereby allowing the worker to more efficiently manage and utilize photographic information from the building, and the worker may check work information of other workers who perform safety assessment together in the same space through the worker terminal to increase efficiency of the safety assessment work, and a worker terminal installed with a program for executing the method for managing photographic information in a safety assessment target building.

### BACKGROUND ART

Commonly, a worker who visits a safety assessment target building for performing a safety assessment due to aging of the building, such as an occurrence of cracks, moves around inside the building while holding plan views for each floor of the building and captures an image of inspection target areas such as an area where cracks have occurred in a wall.

As described above, the worker moves through each floor of the building, takes dozens of pictures, and then writes a building assessment report. During this process, in general, the worker separately marks photographing positions and photographing directions of the worker who took each picture on the plan views for each floor.

Meanwhile, during writing a building assessment report, in order to mark the photographing positions and photographing directions on the plan views for each floor, the worker should photograph the inspection target areas in advance while moving around inside the building, and separately record the photographing positions and photographing directions for each picture. However, due to various on-site conditions at the diagnosis site, cases where it is difficult to take pictures and record accurately occur frequently.

In addition, in order to write the building assessment report, memo information such as the worker's comments during the on-site inspection process and reference data such as test reports are required. However, cases where it is difficult for the worker to take pictures of the inspection target area and record the memo or reference data information at the same time occur frequently.

### SUMMARY OF INVENTION

### Problems to be Solved by Invention

Therefore, it is an object of the present invention to provide a method for managing photographic information in a safety assessment target building, in which not only photographing point and photographing direction information corresponding to each photographic image taken by a worker while moving within a photographing space of the building etc. may be additionally generated in a drawing image of the corresponding photographing space, but also memo information and reference data information of a worker may be stored in association with the photographic image along with photography, thereby allowing the worker to more efficiently manage and utilize photographic information from the building, and the worker may check work information of other workers who perform safety assessment together in the same space through the worker terminal to increase efficiency of the safety assessment work, and a worker terminal installed with a program for executing the method for managing photographic information in a safety assessment target building.

### Means for Solving Problems

To achieve the above object, according to an aspect of the present invention, there is provided a method for managing photographic information in a safety assessment target building including: (a) capturing, by a worker terminal, a photographic image of an inspection target area in a photographing space, which is a space where a worker performs photography; (b) storing, by the worker terminal, a voice memo of the worker in association with the photographic image of the inspection target area; and (c) generating, by the worker terminal, icons for calling information including an icon for calling the photographic image and an icon for calling the voice memo on a drawing image of the photographing space.

Preferably, the method further includes: (d) receiving, by the worker terminal, selection information of the worker on the icon for calling information; and (e) receiving, by the worker terminal, work information corresponding to the icon for calling information selected by the worker.

In addition, the method may further include, after the step (b) and the before step (c), converting, by the worker terminal, the voice memo into text information and storing the text information in association with the photographic image.

In addition, the method may further include (d) additionally generating, by the worker terminal, an icon for calling work information of the other workers received from a management server that has received the work information of the other workers from terminals of the other workers who perform work together in the photographing space on the drawing image of the photographing space.

Further, there is provided a worker terminal including a program installed therein to execute the method for managing photographic information in a safety assessment target building.

### Advantageous Effects

According to the present invention, not only photographing point and photographing direction information corresponding to each photographic image taken by a worker while moving within a photographing space of the building etc. may be additionally generated in a drawing image of the corresponding photographing space, but also memo information and reference data information of a worker may be stored in association with the photographic image along with photography, thereby allowing the worker to more efficiently manage and utilize photographic information from the building.

In addition, according to the present invention, the worker may check work information of other workers who perform safety assessment together in the same space through the worker terminal to increase efficiency of the safety assessment work.

### BRIEF DESCRIPTION OF DRAWINGS

FIG. 1 is a procedural flowchart describing execution processes of a method for managing photographic information in a safety assessment target building according to an embodiment of the present invention.

FIGS. 2 to 6 are diagrams illustrating screen statuses of a worker terminal in the process of executing the method for managing photographic information in a safety assessment target building according to an embodiment of the present invention.

FIG. 7 is a procedural flowchart describing a voice memo storage method in the process of executing the method for managing photographic information in a safety assessment target building according to an embodiment of the present invention.

FIG. 8 is a diagram illustrating the state of generating an icon for calling work information of a worker in the method for managing photographic information in a safety assessment target building according to an embodiment of the present invention.

FIG. 9 is a view illustrating a configuration of a building photographic information management system through a network according to an embodiment of the present invention.

FIG. 10 is a diagram illustrating the state of generating icons for calling work information of a plurality of workers in the method for managing photographic information in a safety assessment target building according to an embodiment of the present invention.

### MODE FOR CARRYING OUT INVENTION

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

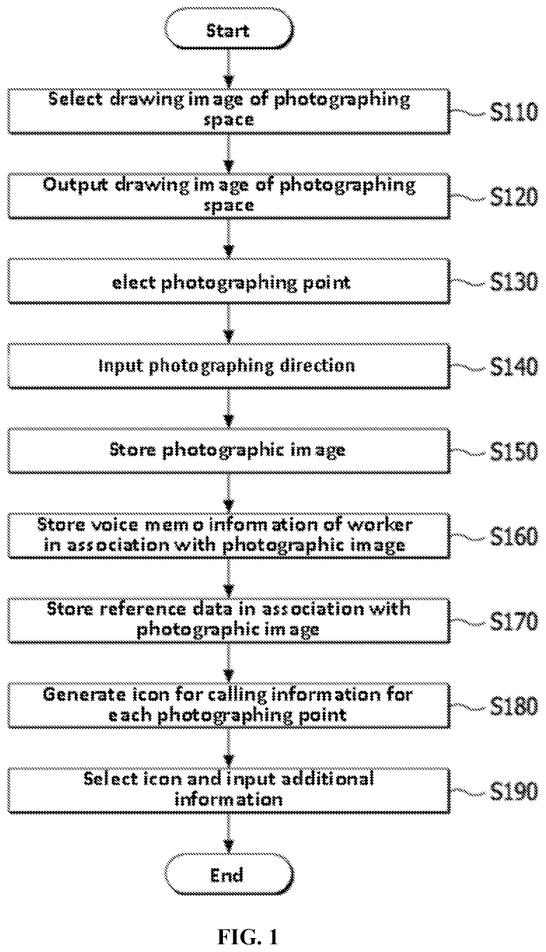

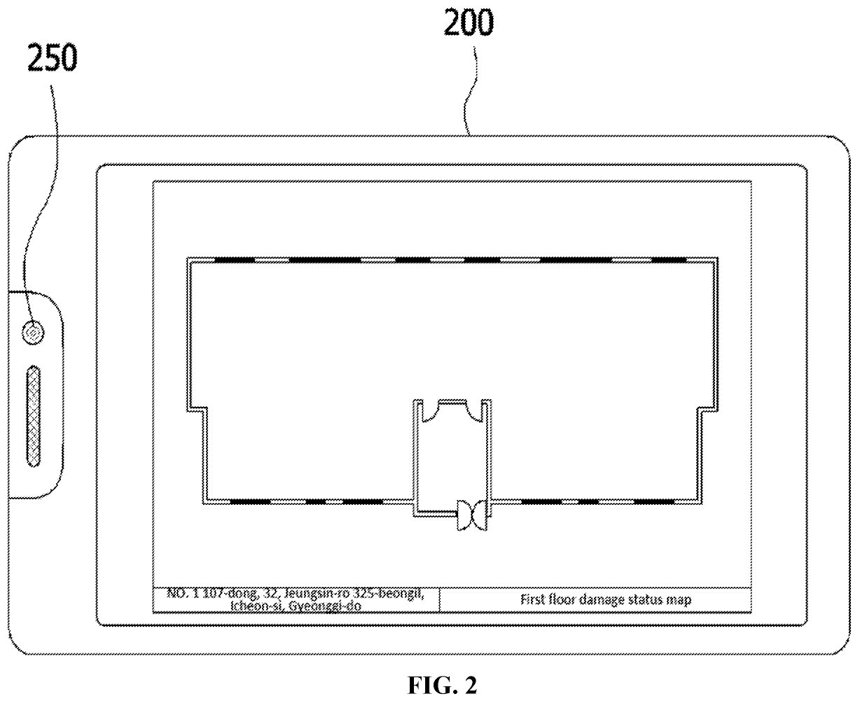

FIG. 1 is a procedural flowchart describing execution processes of a method for managing photographic information in a safety assessment target building according to an embodiment of the present invention, and FIGS. 2 to 6 are diagrams illustrating screen statuses of a worker terminal in the process of executing the method for managing photographic information in a safety assessment target building according to an embodiment of the present invention.

Meanwhile, a worker terminal 200 in the present invention may be a wireless communication terminal such as a smartphone or tablet PC possessed by a worker who performs safety assessment of a building, and the worker terminal 200 may include an application program installed therein to execute the method for managing photographic information according to the present invention.

Hereinafter, execution processes of the method for managing photographic information in a safety assessment target building according to an embodiment of the present invention will be described with reference to FIGS. 1 to 6.

First, a worker who visits a safety assessment target building for inspection due to aging of the building, such as an occurrence of cracks selects a plan view image file of a floor currently being diagnosed among the plan view image files for each floor of the corresponding building stored in the worker terminal 200 (S110).

Specifically, when the worker is conducting a safety assessment on the first floor of the corresponding building, the worker selects a plan view image file of the first floor among the plan view image files for each floor stored in the worker terminal 200, and thus the plan view image of the corresponding floor is output on a screen of the worker terminal 200 as shown in FIG. 2 (S120).

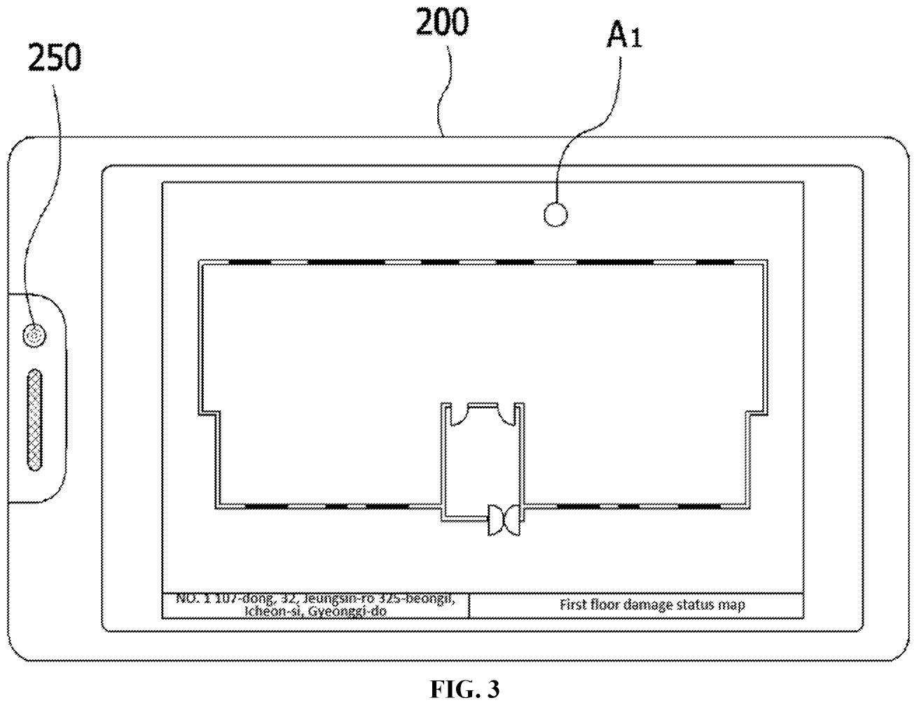

Thereafter, when the worker who performs a safety assessment while moving around inside of the corresponding floor checks an inspection target area such as an area where cracks occur in a wall, and determines to capture an image of the corresponding area, the worker selects the current position where he or she is standing on the plan view image of the corresponding floor displayed on a screen of the worker terminal 200 in a manner of touching the screen, etc., as shown in FIG. 3 (S130).

Meanwhile, the worker terminal 200 processes and records the current position selected by the worker on the plan view image of the corresponding floor displayed on the screen of the worker terminal 200 as a photographing point A, which is a position of the worker who captures an image of the inspection target area.

Accordingly, a first photographing point A1 of the worker is displayed on the screen of the worker terminal 200 as shown in FIG. 3, then the worker checks the position of the inspection target area on the plan view image of the corresponding floor displayed on the screen of the worker terminal 200, and then touches the photographing point A1 on the screen of the worker terminal 200 with his or her finger. In this state, a swipe motion, which is an operation of moving the finger from the photographing point A1 toward the inspection target area, may be performed (S140).

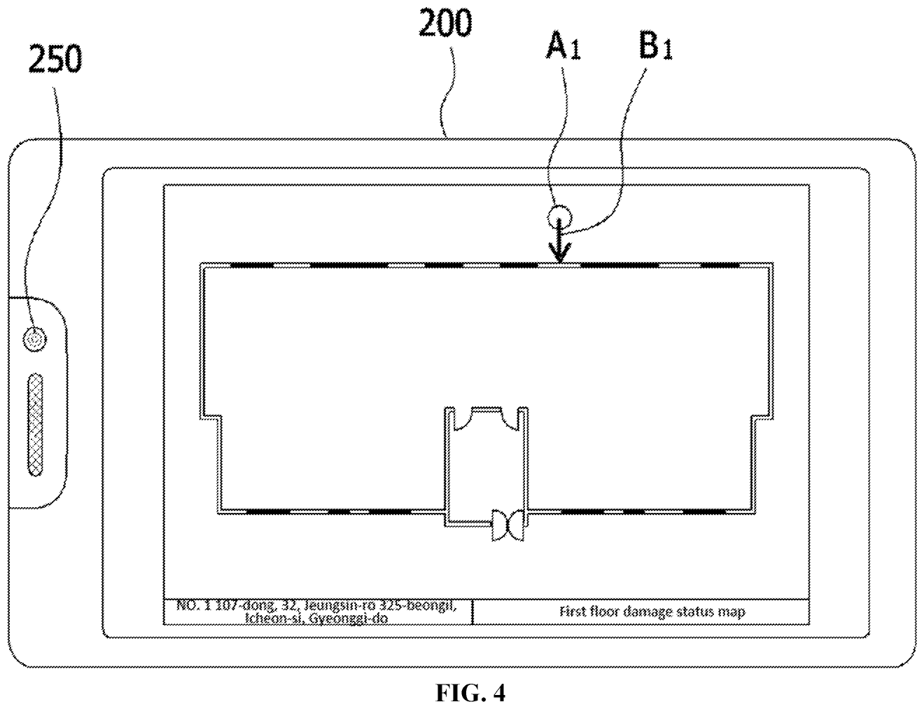

Accordingly, the worker terminal 200 may detect the worker's swipe motion and generates information on a photographing direction B1 at the photographing point A1 based on swipe direction information of the worker as shown in FIG. 4, then display the generated information on the photographing direction B1 on the plan view image of the corresponding floor as shown in FIG. 4.

Thereafter, as shown in FIG. 4, the worker captures an image of the inspection target area such as a crack occurrence area of a wall using a camera module 250 provided in the worker terminal 200 in the photographing direction B1 displayed on the screen of the worker terminal 200 while standing at the current position corresponding to the photographing point A1 displayed on the screen of the worker terminal 200. Then, the photographic image of the inspection target area is stored in an internal memory provided in the worker terminal 200 (S150).

Meanwhile, in carrying out the present invention, it is preferable that the worker terminal 200 stores information on the photographing point A1 selected by the worker in the step S130 and the information on the photographing direction B1 in the step S140 in association with the photographic image stored in the above-described step S150.

In addition, in carrying out the present invention, it is preferable that the worker terminal 200 stores information on the photographing order at the diagnosis site of the corresponding photographic image in association with the photographic image stored in the above-described step S150.

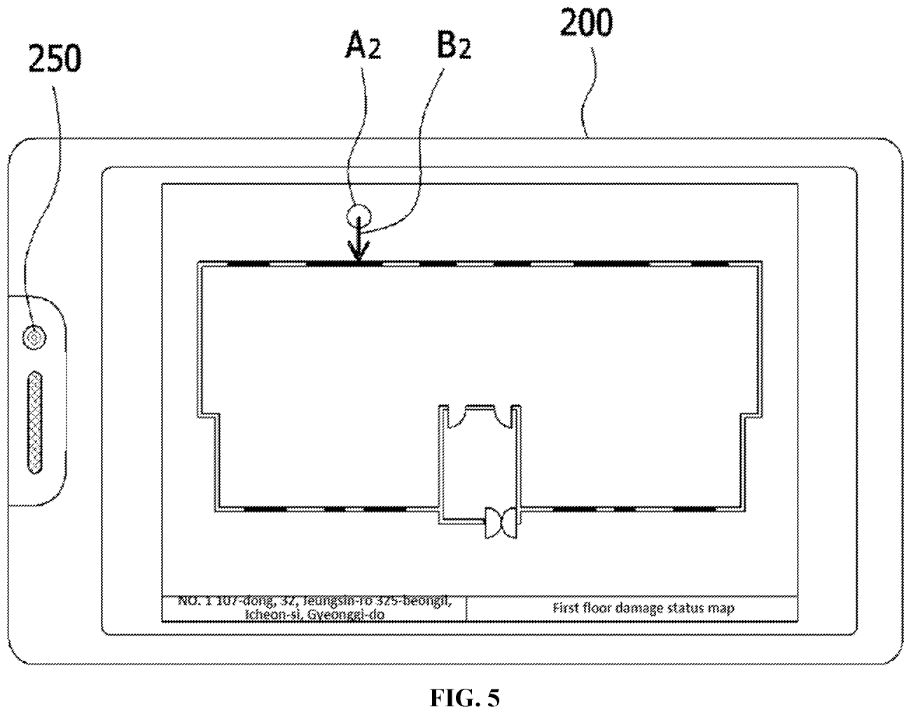

After completing the photographing at the first photographing point A1 as described above, when the worker determines to capture an image of a second inspection target area while moving around inside of the corresponding floor, it is possible to input information on a second photographing point A2 and information on a second photographing direction B2 in the same method as the above-described step S130 and step S140 as shown in FIG. 5.

Then, when the photographing at the second photographing point A2 is completed, the worker terminal 200 repeatedly performs the process of storing the photographic image and storing in association with the photographing order, photographing point and photographing direction information in the above-described step S150, and the worker performs additional photographing on the corresponding floor in the same manner as described above, and then may perform photographing in the same manner on the next floor (for example, the second floor).

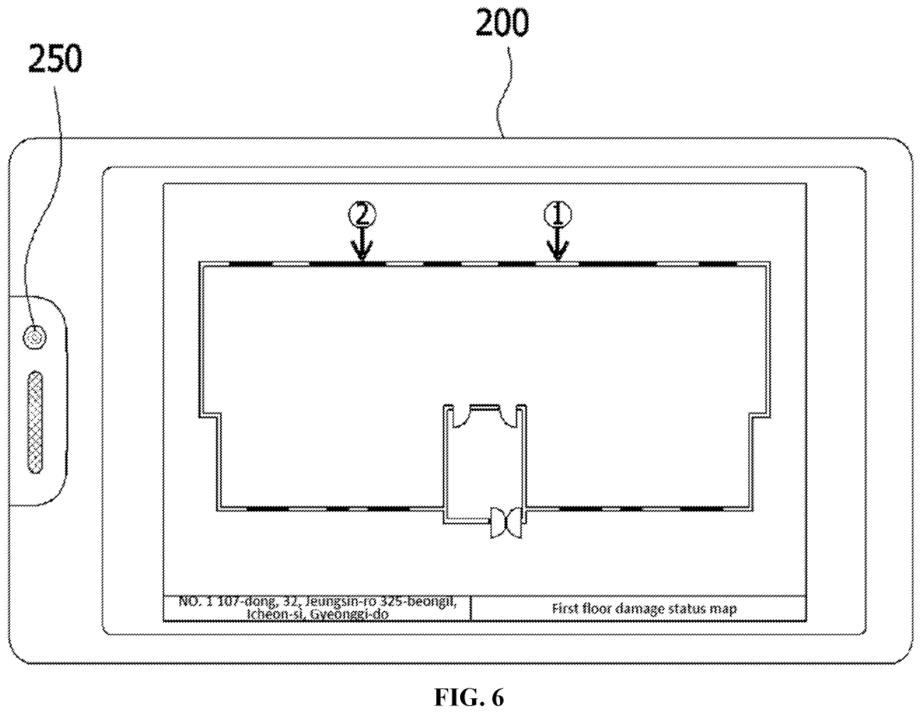

Meanwhile, it is preferable that the worker terminal 200 performs overlapping the photographing point information and photographing direction information stored in association with each photographic image captured and stored in the continuous photographing process as described above so as to be additionally generated on the plan view image selected by the worker in the above-described step S110 as shown in FIG. 6, thereby generating a plan view image for writing a building assessment report.

In addition, in practicing the present invention, the worker may store his/her voice memo during the work process in association with the photographic image stored in step S150 (S160).

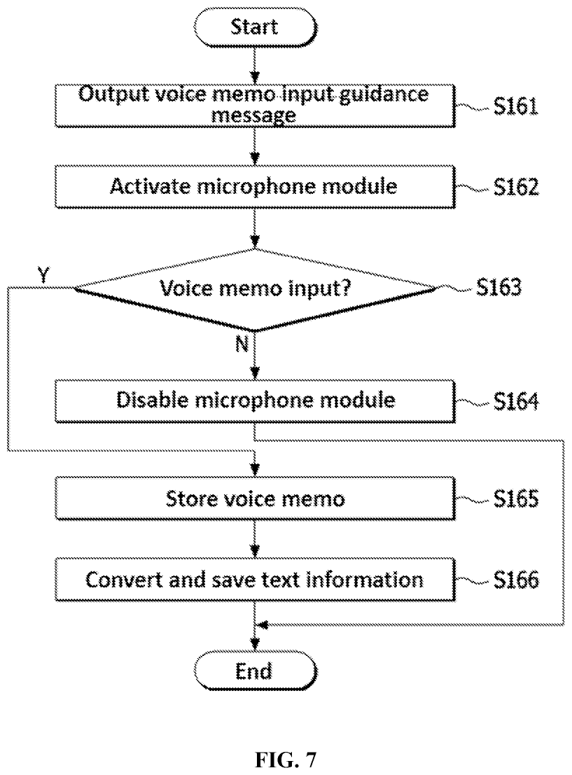

FIG. 7 is a procedural flowchart describing a voice memo storage method in the process of executing the method for managing photographic information in a safety assessment target building according to an embodiment of the present invention. Hereinafter, the process of storing a voice memo in association with the photographic image will be described with reference to FIG. 7.

First, the worker terminal 200 that has completed storage of the photographic image and storage in association with the photographing order, the photographing point and the photographing direction information in the above-described step S150 may output a voice memo input guidance message such as ‘The work information has been stored.’, “Please leave a comment on your work.’, and the like through a speaker module provided in the worker terminal 200 (S161).

The worker terminal 200 outputs the voice memo input guidance message as described above, then activates a microphone module provided in the worker terminal 200 (S162), and waits for voice input from the worker (S163).

If there is no voice input from the worker within a predetermined time (for example, 5 seconds), the worker terminal 200 determines that there is no voice memo of the worker for the corresponding photographic image and disables the microphone module (S164), whereas when voice information is input through the microphone module, the worker terminal 200 stores the input voice information in association with the corresponding photographic image (S165).

In addition, the worker terminal 200 may convert the voice information of the worker into text information to automatically generate text memo information of the worker, and additionally store the generated text memo information in association with the corresponding photographic image (S166).

Further, in carrying out the present invention, the worker may store reference data such as the test report in association with the photographic image stored in the above-described step S150 (S170).

Specifically, the worker terminal 200 that has completed the storage of the photographic image and the storage in association with the photographing order, the photographing point and the photographing direction information in the above-described step S150 may display a reference data file import icon on the screen of the worker terminal 200. Thereby, when the worker selects the corresponding icon and then selects the reference data file such as the test report previously stored in the worker terminal 200, the worker terminal 200 may store the reference data file selected by the worker in association with the corresponding photographic image.

As such, according to the present invention, the worker may store his/her work voice memo, text memo, and reference data in association with the corresponding photographic image immediately after completing the photographing at each photographing point in the photographing space.

That is, according to the present invention, not only photographing point and photographing direction information corresponding to each photographic image taken by a worker while moving within a photographing space of the building etc. may be additionally generated in a drawing image of the corresponding photographing space, but also the memo information of the worker such as comments at the time of photographing, and reference data information such as test reports required when writing the building assessment report are stored in association with the corresponding photographic image, thereby allowing the worker to more efficiently manage and utilize photographic information from the building.

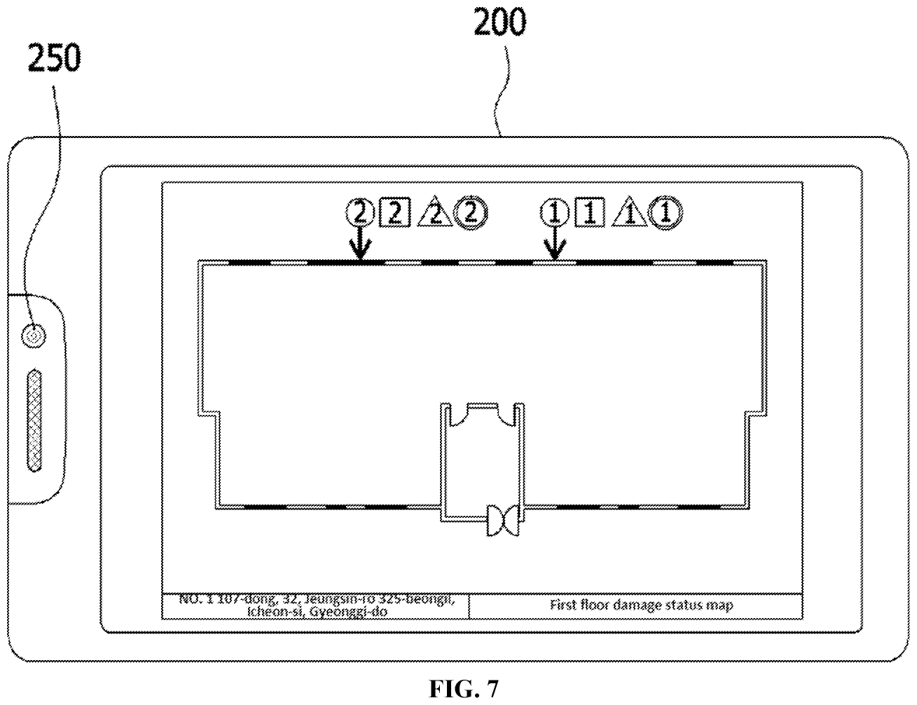

Meanwhile, in carrying out the present invention, the worker terminal 200 may generate an icon \textcircled{1} for calling the photographic image including a serial number for indicating the photographing order at the photographing point on the plan view image selected by the worker in the above-described step S110 as shown in FIG. 8, and generate an icon for calling the voice memo [symbol] , an icon for calling the text memo [symbol] , and an icon for calling the reference data [symbol] , which include the same serial number, adjacent to the corresponding icon (S180).

In addition, in carrying out the present invention, when information corresponding to each icon is stored in the worker terminal 200, the worker terminal 200 displays the corresponding icon in a chromatic color such as blue, whereas if the information corresponding to the icon is not stored therein, the worker terminal 200 displays the corresponding icon in an achromatic color such as gray, so that the worker can check the input status of work-related information through the color of the icon.

Meanwhile, thereafter, when the worker selects an icon for calling each information which is additionally generated and displayed on the plan view image selected by the worker in the above-described step S110 on a touch-sensitive display of the worker terminal 200 as shown in FIG. 8, the worker terminal 200 may output work information stored in association with the corresponding icon.

Specifically, when the worker selects the icon [symbol] for calling the photographic image, the worker terminal 200 may display the photographic image stored in association with the corresponding icon on the screen of the worker terminal 200, when the worker selects the icon [symbol] for calling the voice memo, the worker terminal 200 may output the voice memo stored in association with the corresponding icon through the speaker module, when the worker selects the icon [symbol] for calling the text memo, the worker terminal 200 may output the text memo stored in association with the corresponding icon on the screen, and when the worker selects the icon [symbol] for calling the reference data, the worker terminal 200 may display the reference data images such as the test report stored in association with the corresponding icon on the screen.

As described above, by selecting the icon for calling each information, the worker who has checked the corresponding work information may also perform an editing work for the corresponding information by selecting editing function buttons such as Re-input, Edit, and Delete buttons displayed on the screen of the worker terminal 200 (S190).

Specifically, when the worker who has checked the voice memo by selecting the icon for calling the voice memo selects the ‘Re-input’ button, the worker terminal 200 may activate the microphone module, then store the voice memo of the worker input through the microphone module by replacing the previously stored voice memo in association with the corresponding icon, and convert the replaced and stored voice memo into a text memo, then store the converted text memo in association with the corresponding icon for calling the text memo by replacing the previously stored text memo.

In addition, when the worker who has checked the text memo by selecting the icon for calling the text memo selects the ‘Edit’ button, the worker terminal 200 may activate a touch-sensitive keypad on the touch-sensitive display of the worker terminal 200 so that the worker can edit the text memo, and may modify and store the text memo according to the information input by the worker through the touch-sensitive keypad.

In addition, when the worker who has checked the reference data such as the test report by selecting the icon for calling the reference data selects the ‘Delete’ button, the worker terminal 200 may delete the reference data stored in association with the corresponding icon, and change the color (for example, chromatic color→achromatic color) of the corresponding icon, thereby allowing the worker to check that there is no information stored in association with the corresponding icon.

Meanwhile, in carrying out the present invention, the worker may select the icon for calling information in which the associated information is stored from the icons for calling each information which are additionally generated in the drawing image as shown in FIG. 8, and then input the related work information.

Specifically, the worker may select an icon for calling the voice memo, which is displayed in achromatic color because the related work information is not stored, and in this case, the worker terminal 200 may repeatedly perform the above-described steps S161 to S166.

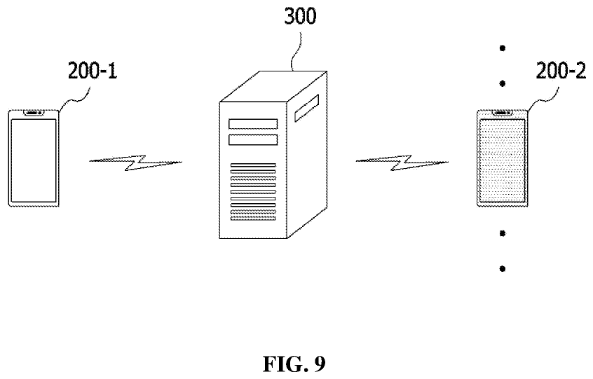

FIG. 9 is a view illustrating a configuration of a building photographic information management system through a network according to an embodiment of the present invention. Referring to FIG. 9, the building photographic information management system through a network according to an embodiment of the present invention includes a plurality of worker terminals 200-1 and 200-2, and a management server 300.

The plurality of worker terminals 200-1 and 200-2 are worker terminals 200-1 and 200-2 respectively possessed by a plurality of workers who perform assessment work together in the same building, and the management server 300 may receive various work information according to the execution of the method for managing photographic information in a safety assessment target building as described above in the worker terminals 200-1 and 200-2 together with ID information of the worker terminals such as universally unique identifiers (UUIDs) of the worker terminals 200-1 and 200-2, and assign serial numbers to each work information according to the order in which each work information is received.

Specifically, as a first worker terminal 200-1 stores the photographic image in the above-described step S150, the management server 300 receives the work information including identification information, the photographing point information, the photographing direction information and the photographic image of the plan view image selected by the worker in the above-described step S110 from the first worker terminal 200-1, and then, as a second worker terminal stores the photographic image in the above-described step S150, the management server 300 receives the work information including identification information, the photographing point information, the photographing direction information and the photographic image of the plan view image selected by the worker in the above-described step S110 from the second worker terminal. In this case, the management server 300 may generate ‘1’ for the work information received from the first worker terminal 200-1 as work order information, and generate ‘2’ for the work information received from the second worker terminal as work order information.

Thereafter, the management server 300 transmits the work order information 1 generated by the management server 300 to the first worker terminal 200-1, and the management server 300 may further transmit the work information received from the second worker terminal and the work order information 2 generated for the corresponding work information to the first worker terminal 200-1.

Accordingly, the first worker terminal 200-1 that has received the work order information 1 from the management server 300 may store the work order information 1 in association with the photographic image in the above-described step S150.

In carrying out the present invention, the first worker terminal 200-1 may store the work order information received from the management server 300 by distinguishing it from the above-described photographing order information, and may also store the work order information by replacing the photographing order information.

In addition, the first worker terminal 200-1 that has received the work information of the second worker and the work order information 2 generated for the corresponding work information from the management server 300 may store the photographing point information and the photographing direction information included in the work information of the second worker and the work order information 2 in association with the photographic image of the second worker included in the work information of the second worker, then search for the corresponding plan view image stored in the first worker terminal 200-1 based on the identification information of the plan view image included in the work information of the second worker and selected by the second worker in the above-described step S110, and perform overlapping the photographing point information, photographing direction information and the work order information included in the work information of the second worker so as to be additionally generated on the searched plan view image.

In addition, in carrying out the present invention, the first worker terminal 200-1 may generate an icon for calling the photographic image of the second worker including a serial number for indicating the work order at the corresponding photographic point on the searched plan view image. As a result, the first worker may select the corresponding icon on the screen of the first worker terminal 200-1, thus to output the photographic image of the second worker stored in association with the corresponding icon through the screen of the first worker terminal 200-1.

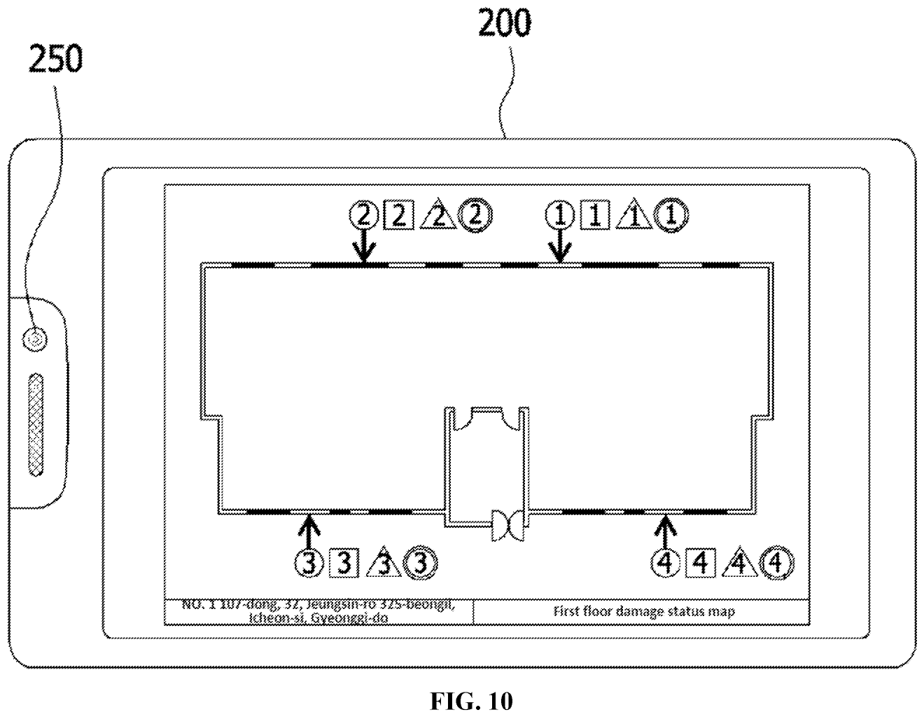

As described above, according to the present invention, the first worker may check not only his or her own work information but also the work information of the second workers, other workers working in the same building, together with the work order information within the corresponding building through the screen of the first worker terminal 200-1 as shown in FIG. 10.

Meanwhile, in carrying out the present invention, the first worker terminal 200-1 differentially display the work information of the first worker and the related icons from the work information and related icons of other workers including the second worker, by color, shape, size, etc., thereby allowing the first worker to distinguish between his or her work information and the work information of other workers.

In addition, in carrying out the present invention, the first worker terminal 200-1 may provide mode selection buttons through the screen of the first worker terminal 200-1 so that the first worker can select ‘My work view mode’ and ‘Building entire work view mode’ on the first worker terminal 200-1.

Accordingly, as shown in FIG. 8, the first worker terminal 200-1 may display only the work information of the first worker and the related icons together with photography order information of the first worker when the ‘My work view mode’ is selected, and collectively display the work information of the first worker and the related icons and the work information and the related icons of other workers including the second worker together with the work order information received from the management server 300.

In addition, when the second worker terminal stores the voice memo and reference data information in the photographic image as in the steps S160 and S170 described above, the management server 300 may receive a request for registering additional information (‘additional information registration request’) including the associated storage information such as the identification information, the photographic image of the plan view image selected by the worker in the above-described step S110, and the voice memo, the text memo and the reference data, which are stored in association therewith from the second worker terminal.

Therefore, the management server 300 may search for the work order information previously generated and stored in the management server 300 for the corresponding photographic image based on the photographic image included in the additional information registration request, and transmit the additional information registration request together with the searched work order information to the first worker terminal 200-1.

Accordingly, the first worker terminal 200-1 may search for the corresponding plan view image based on the identification information of the plan view image included in the additional information registration request received from the management server 300, search for the icon for calling the photographic image additionally generated in the corresponding plan view image based on the work order information received from the management server 300 together, and then store the associated storage information such as the voice memo, the text memo and the reference data included in the additional information registration request received from the management server 300 in association with the photographic image stored in association with the searched icon for calling the photographic image.

Through this, the storage state in association with the corresponding work information of each photographic image generated by the second worker through the second worker terminal is formed in the first worker terminal 200-1 in the same manner.

In addition, in carrying out the present invention, the first worker terminal 200-1 may generate an icon for calling the voice memo of the second worker, an icon for calling the text memo of the second worker, and an icon for calling the reference data of the second worker including the same serial number (work order number) adjacent to the icon for calling the photographic image of the second worker previously generated at the photographing point on the corresponding plan view image.

Then, the first worker may select each icon on the screen of the first worker terminal 200-1, thereby outputting and checking the voice memo, the text memo and the reference data of the second worker stored in association with the corresponding icon through the first worker terminal 200-1.

As described above, according to the present invention, the worker may check the work information of other workers who perform the work together in the same building in real time through his or her own terminal, thereby increasing the efficiency of safety assessment and inspection work of the building.

In addition, in carrying out the present invention, the first worker terminal 200-1 may analyze voice information in the voice memo of the second worker received from the management server 300, thereby generating identification information of a worker who has spoken the memo (‘speaker identification information’) for mutual identification between the second workers, and differentially form the color, shape, size, etc. of the icon for calling information for each photographing point of each second worker based on the generated speaker identification information, so that the first worker can visually distinguish the sources of each work information output through the first worker terminal 200-1.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the technical field related to safety assessment of buildings, such that industrial applicability thereof is recognized.

The invention claimed is:

1. A method for managing photographic information in a safety assessment target building comprising:
(a) capturing, by a worker terminal, a photographic image of an inspection target area in a photographing space, which is a space where a worker performs photography;
(b) storing, by the worker terminal, a voice memo of the worker in association with the photographic image of the inspection target area; and
(c) generating, by the worker terminal, icons for calling information including an icon for calling the photographic image and an icon for calling the voice memo on a drawing image of the photographing space.

2. The method for managing photographic information in a safety assessment target building according to claim 1, further comprising, after the step (b) and the before step (c),
converting, by the worker terminal, the voice memo into text information and storing the text information in association with the photographic image.

3. The method for managing photographic information in a safety assessment target building according to claim 1, further comprising: (d) additionally generating, by the worker terminal, an icon for calling work information of the other workers received from a management server that has received the work information of the other workers from terminals of the other workers who perform work together in the photographing space on the drawing image of the photographing space.

4. A worker terminal comprising a program installed therein to execute the method for managing photographic information in a safety assessment target building according to claim 1.

5. A worker terminal comprising a program installed therein to execute the method for managing photographic information in a safety assessment target building according to claim 2.

6. A worker terminal comprising a program installed therein to execute the method for managing photographic information in a safety assessment target building according to claim 3.
